(19) United States
(12) Patent Application Publication
(10) Pub. No.: US 2011/0024581 A1
(43) Pub. Date: Feb. 3, 2011

(54) Drink holder with utility hook

(76) Inventor: Vincent A. Giagni, SR., Purchase, NY (US)

Correspondence Address: James W. Badie, Esq.,;Law Offices of James W. Badie, Suite 3300, 521 Fifth Avenue, New York, NY, 10175-3399, US

(21) Appl. No.: 12/462,010

(22) Filed: Jul. 28, 2009

(51) Int. Cl. F16M 11/04

(52) U.S. Cl. 248/121

(57) ABSTRACT

A drink holder with utility hook is provided which comprises a single shaft having a lower end for securely inserting into an outdoor ground, and an upper spiraled section defined by a plurality of convolutions dimensioned to hold a beverage receptacle. A utility hook is formed at the upper end of the spiral structure for hanging keys, sunglasses or other accessories.

### FIELD OF THE INVENTION

This invention relates to receptacle support assembly and is particularly related to receptacle support structure such as a drink holder with utility hook for outdoor use. In one particular aspect, the present invention relates to a drink holder with a utility hook for such items as key chains, sunglasses, cigars, cigarettes and the like.

### BACKGROUND OF THE INVENTION

A variety of outdoor drink holders and receptacle support assemblies have been in use for a long time and have been described in several patents. For example, U.S. Pat. No. 2,520,818 issued Aug. 29, 1950, describes a receptacle support for supporting glasses and bottles at the upper end of a stake formed of a single piece of wire with a plurality of spiral convolutions at the upper end for holding the receptacle. The stake is forced into the ground at its lower end adjacent a chair and the like used by an outdoor occupant with ready access to the receptacle.

A drink container mounting ground stake is described in U.S. Pat. No. 4,334,661 issued Jun. 15, 1982. The stake has a pointed bottom for forcing it into the ground and a ring extending laterally from the stake for holding a drink container above the ground.

A more recent patent, i.e., U.S. Pat. No. 5,570,863 issued Nov. 5, 1996 describes a drink holder for outdoor use. This drink holder includes plastic tubing having an upper spiraled structure for holding a liquid container, and a pointed lower end for insertion into the ground.

So far as it is known the prior art patents are primarily directed only to drink holders and the like structures for holding beverage receptacles for outdoor use.

It is therefore a primary object of the present invention to provide a combination drink holder with a utility hook for outdoor use.

It is a further object of this invention to provide a combination drink holder for holding a drink and a utility hook at the upper end of the drink holder for hanging various items such as key chains, sunglasses, cigars, cigarettes, etc.

It is also an object of the present invention to provide a drink holder with utility hook, formed from a single shaft having a lower end rigidly inserted in the ground, outdoor near a chair, a table or other outdoor seating areas.

The foregoing and other objects of this invention will be more fully comprehended from the following detailed description and the accompanying drawings.

### SUMMARY OF THE INVENTION

This invention provides a drink holder with utility hook intended for outdoor use. The drink holder comprises an elongated single shaft having a lower end terminating in a tip for forcing the shaft securely into an outdoor ground. The upper end of the shaft is spiraled and is defined by a plurality of horizontally disposed convolutions dimensioned to hold a beverage receptacle. The uppermost spiral or convolution is formed into a generally V-shaped utility hook shaped for hanging keys, sunglasses or retaining cigars and cigarettes of different sizes and diameters. The drink holder-utility hook structure is secured in the ground near a chair, a table, a seat or the like for ready accessibility by the user.

### DESCRIPTION OF THE DRAWINGS

In the drawings wherein like reference numerals are used to designate like parts:

FIG. 1 is a front elevational view of the drink holder with utility hook according to the present invention, having an elongated shaft with its lower end inserted into the ground and having an upper spiral section for holding a drink receptacle and having a utility hook;

FIG. 2 is an enlarged view of the utility hook of the drink holder—utility hook structure shown in FIG. 1;

FIG. 3 is an enlarged view of the upper spiral section of the drink holder without the receptacle; and

FIG. 4 is a top view of the spiral section shown in FIG. 3 showing the bottom of the spiral for supporting the drink receptacle.

### DETAILED DESCRIPTION OF THE INVENTION

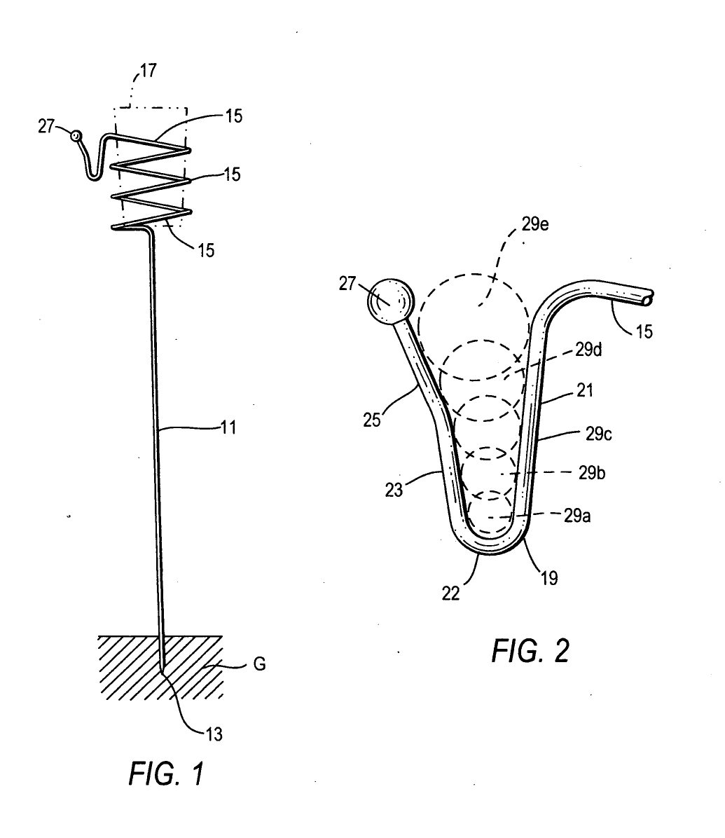

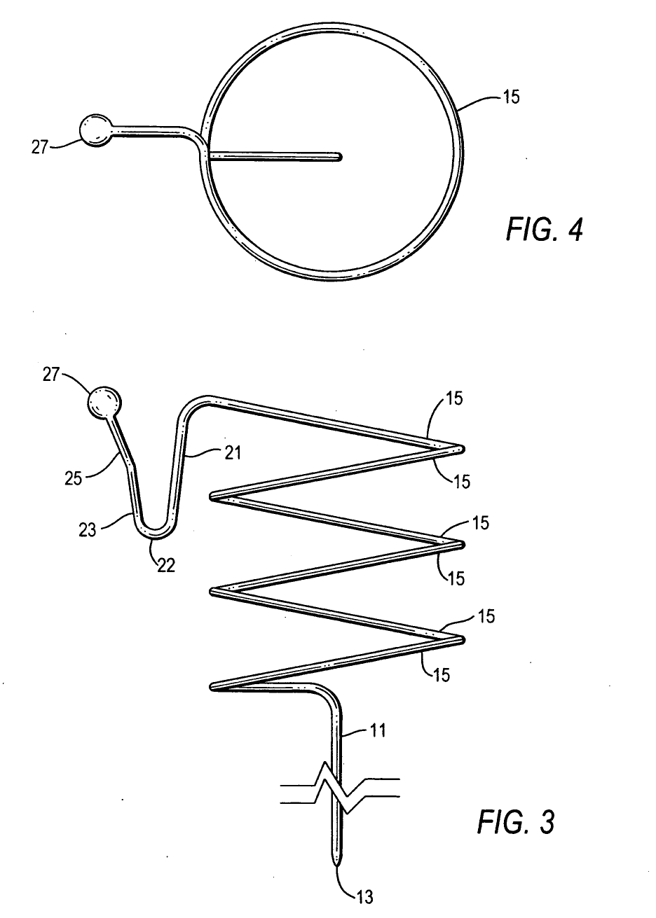

Referring to FIGS. 1-4 of the drawings, the support structure for the drink receptacle comprises an elongated upright single length shaft 11 made of plastic or other rigid material, having a rounded lower tip 13 securely inserted into the ground G. The upper end of the shaft 11 terminates in a spiral section defined by a plurality of horizontal convolutions 15 which are dimensioned to securely hold the drink holder 17. Naturally, the height of the shaft 11 can vary as desired and the number of convolutions 15 as well as their diameter can vary depending on the size of the drink holder.

Referring once again to the drawings, it can be seen that the uppermost spiral or convolution 15 is formed into a generally V-shaped member 19 having one arm 21 formed by extending and bending the uppermost convolution 15 downward and spaced a distance away from the spiral section, ten bent slightly as in 22 and thereafter upwardly as in 23 and further upwardly and diagonally at a slight angle as in 25, terminating in a safety round tip 27 formed at the end of the diagonal arm 27 or separately attached thereto. Thus, it can be seen that the generally V-shaped member 19 can serve and used as a utility hook for key chains, sunglasses, and other accessories by hanging such items on the hook. Also the utility hook can be used for retaining cigars or cigarettes of varying diameters as shown by the dashed lines defining the perimeters of the different size cigars or cigarettes 29a, 29b, 29c, 29d and 29e.

As it can be seen from the foregoing description, the drink holder with its utility hook of this invention can be rigidly fixed into the ground, outdoor in a picnic area or on a lawn, near a chair or convenient seat and the drink holder is retained within the spiral section near the chair for ready access by the user. Other items such as key chains, sunglasses, cigars, cigarettes, etc., may be conveniently placed on the utility hook, all within ready accessibility.

Various changes or modifications are evident from the detailed description herein. These include the length of the shaft, its materials of construction, the diameter of the drink holding spiral section and the number of convolutions defining the spiral section, all for the purpose of providing a rigid drink holder structure with utility hook. Such changes and modifications are obvious from and are within the scope of this invention.

1. A beverage retaining structure with utility hook for outdoor use comprising an upright elongated single shaft having a lower end terminating in a tip adapted to be forced into the ground for securely maintaining said shaft, an upper end formed into a spiral section defined by a plurality of horizontal convolutions dimensioned to retain a beverage receptacle, said spiral section having an upper end terminating into a utility hook, said utility hook having a generally V-shaped configuration defined by two spaced apart arms, an inner arm formed by bending downwardly the upper end of the spiral, then outwardly curving said inner arm a finite distance and further bending it upwardly and diagonally to form an outer arm of said V-shaped utility hook.

2. A beverage retaining structure as in claim 1 wherein the end of said outer arm of said V-shaped utility hook is provided with a safety tip.
